(19) United States
(12) Patent Application Publication
(10) Pub. No.: US 2015/0192930 A1
(43) Pub. Date: Jul. 9, 2015

(54) METHOD FOR CONTROLLING WATER OUTGOING FROM CONTAINER BY PRESSURE AND DEVICE FOR ACHIEVING THE SAME

(71) Applicant: MAXTEC PLASTICS, INC., TAIHUNG CITY (TW)

(72) Inventor: SHIH PING LEE, TAICHUNG CITY (TW)

(73) Assignee: MAXTEC PLASTICS, INC., TAIHUNG CITY (TW)

(21) Appl. No.: 14/254,005

(22) Filed: Apr. 16, 2014

(30) Foreign Application Priority Data
Jan. 8, 2014 (TW) 103100597
Jan. 29, 2014 (TW) 103103372
Feb. 27, 2014 (TW) 103106610

(51) Int. Cl. G05D 7/01

(52) U.S. Cl. CPC G05D 7/0106

(57) ABSTRACT

A device for controlling water outgoing of a container by pressure includes a motor, an outgoing pipe, a water outgoing unit, a first thin film, a thin film sensing device and a check valve unit. The motor pumps water to a container. The outgoing pipe is connected between the water outgoing unit and the motor. The outgoing pipe has the check valve unit connected thereto. The thin film sensing device is connected beside the outgoing pipe. When the oater outgoing unit is set to be OFF, the pressure in the thin film sensing device increases to let the first thin film protrude to touch the switch of the thin film sensing device to control the motor to pump or not to pump the water.

### BACKGROUND OF THE INVENTION

1. Fields of the invention

The present invention relates to a water supply system, and more particularly, to a water supply system that controls the water outgoing from a container by pressure.

2. Descriptions of Related Art

The conventional water supply system usually uses the potential energy due to gravity of the water and is cooperated with a mechanical water outgoing unit to allow the water outgoing unit to continuously supply the water. Alternatively, some water supply system is equipped with an electronic water outgoing unit with a button and which is electrically connected with a motor in the system, so that when the user keeps on pressing the button, the motor is activated to pump the water to the user via the outlet of the water outgoing unit. There is not any water supply system that uses the pressure difference between the water outgoing unit and the motor to control the motor to be activated to supply water.

The present invention intends to provide a method and a device to control the way of supplying water from a container by using the water pressure. The present invention provides a mechanical water outgoing unit to control the water outgoing by using a thin film sensing device located at the outgoing end to increase or reduce the water pressure in a pressure storage space to control the motor to pump the water.

### SUMMARY OF THE INVENTION

The present invention relates to a device for controlling water outgoing from a container by pressure, and comprises a motor, an outgoing pipe, a water outgoing unit, a first thin film, a thin film sensing device, a check valve unit and a second thin film. The motor pumps water to a container. The water outgoing unit is a mechanical unit and is connected to the distal end of the outgoing pipe. The thin film sensing device is connected to the outgoing pipe and has a connection member and a switch. The connection member is connected to the mediate portion of the outgoing pipe and has a pressure storage space defined therein which communicates with the outgoing pipe. The pressure storage space has the first thin film located therein and the switch is located beside the first thin film. The check valve unit is connected to the outgoing pipe between the thin film sensing device and the motor. The check valve unit has a function of preventing the water from flowing backward.

Preferably, the pressure-storage space has a pressure-storage thin film so as to generate a thin film force. A flow-back water pressure is generated when the water outgoing unit is closed. The sum of the thin film force and the flow-back water pressure is larger than a resistance force when the switch is closed so that the first thin film contacts the switch to set the switch to be OFF.

Preferably, the thin film sensing device comprises an adjustment member which is located beside the switch. The adjustment member has a movable member, an adjustment bolt, a push plate and a spring. The movable member is located between the first thin film and the switch. The adjustment bolt rotatably extends in the connection member. The push plate is in contact with the front end of the adjustment bolt. The spring is biased between the push plate and the movable member.

When the oater outgoing unit is set to be “OFF”, because of the function of the check valve unit, the water is stored in the outgoing pipe. When the water outgoing unit is set to be “ON”, motor starts to pump the water and the water can be supplied to the user. When water outgoing unit is set to be “OFF”, because the motor continuously pumps the water, so that the pressure in the pressure storage space of the thin film sensing device increases to let the first thin film protrude to touch the switch to stop the operation of the motor. Therefore, the mechanical water outgoing unit is able to control the operation of the pump.

The thin film sensing device has the adjustment member, the adjustment member is operated the pressure in the pipe due to the factors of the length of the pipe, the distance that the water is delivered and the head of the water, so that the resistance for protruding the first thin film can be adjusted to increase the sensitivity, the reliability and the stability of the water outgoing unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention;

FIG. 2 is an exploded view of the device of the present invention;

FIG. 3 is an exploded view of the thin film sensing device of the present invention;

FIG. 4 is a side cross sectional view of the device of the present invention;

FIG. 5 is a front partial cross sectional view of the device of the present invention;

FIG. 6 is a side partial cross sectional view of the device of the present invention;

FIG. 7 is a cross sectional view of the thin film sensing device of the device of the present invention;

FIG. 7a is a cross sectional view showing the action of the check valve unit of the device of the present invention;

FIG. 8 shows the operation status of the device of the present invention, and

FIG. 9 is a cross sectional view to show the operation of the thin film sensing device of the device of the present invention.

### DETAILED DESCRIPTION OF THE PREFERRED EMBODIMENT

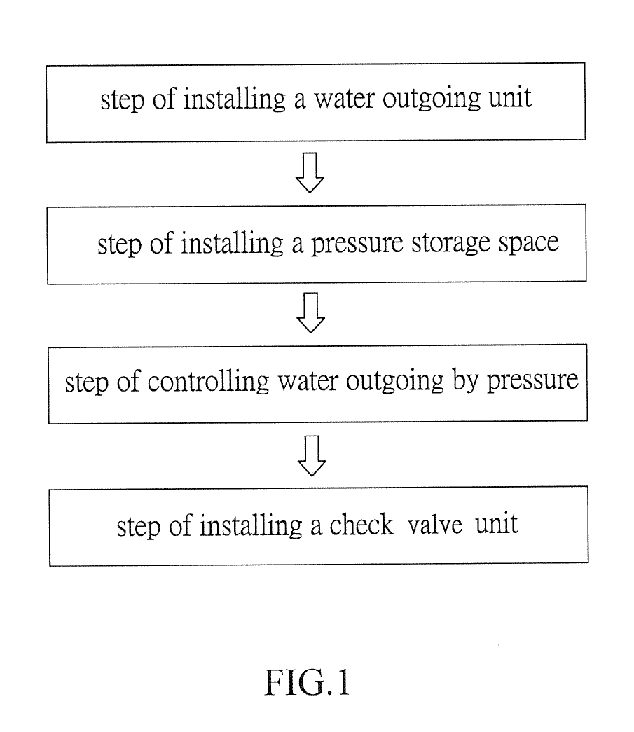

Referring to FIGS. 1, 3 and 7, the method of the present invention uses pressure to control the water outgoing from a container. The present invention further uses a mechanical water outgoing unit and the water pressure to control the operation of the motor. The method of the present invention comprises the following steps: a step of installing a water outgoing unit; a step of installing a pressure storage space; a step of controlling water outgoing by pressure and a step of installing a check valve unit.

In the step of installing a water outgoing unit, a motor 10 is connected to the outside of the container “A” and the motor 10 is further connected with an outgoing pipe 20. The outgoing pipe 20 is connected with a mechanical water outgoing unit 30.

For the step of installing a pressure storage space, a connection member 41 is connected in series with the outgoing pipe 20 which is located between the motor 10 and the water outgoing unit 30. The connection member 41 has a lateral opening 414 to which a switch 42 is connected. A first thin film 416 is connected between the connection member 41 and the switch 42 to form a pressure storage space 415.

For the step of controlling water outgoing by pressure, when the water outgoing unit 30 is opened, the first thin film 416 is horizontally located to set the switch 42 to be “ON” and the motor 10 continuously pumps the water. When water outgoing unit 30 is closed, a pressure is formed in the pressure storage space 415 to deform the first thin film 416 which protrudes to touch the switch 42 to be “OFF”, and the motor 10 is stopped.

For the step of installing a check valve unit, the water outgoing pipe 20 is connected to the front end of the connection member 41. When the motor 10 is stopped, the check valve unit 21 prevents the water in the water outgoing pipe 20 from flowing back into the container “A” to keep a pressure in the pressure storage space 415.

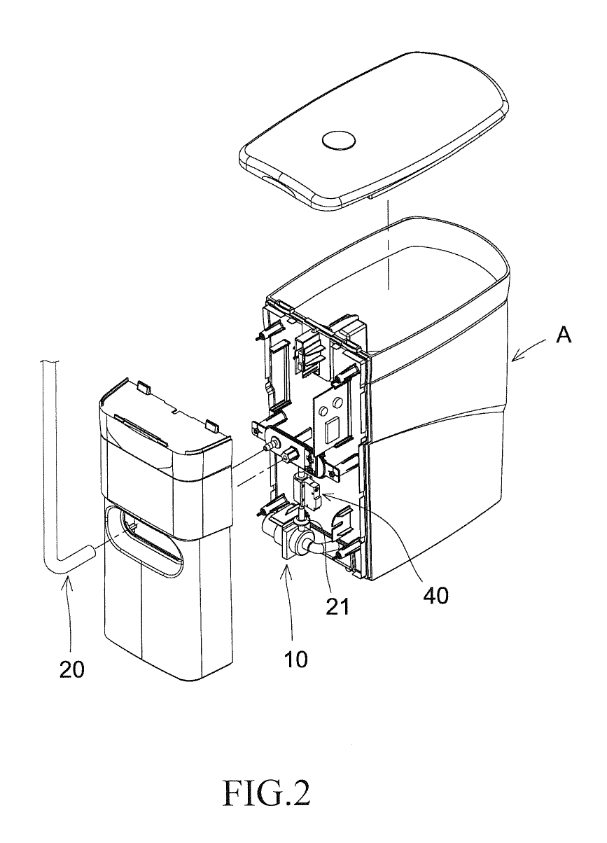

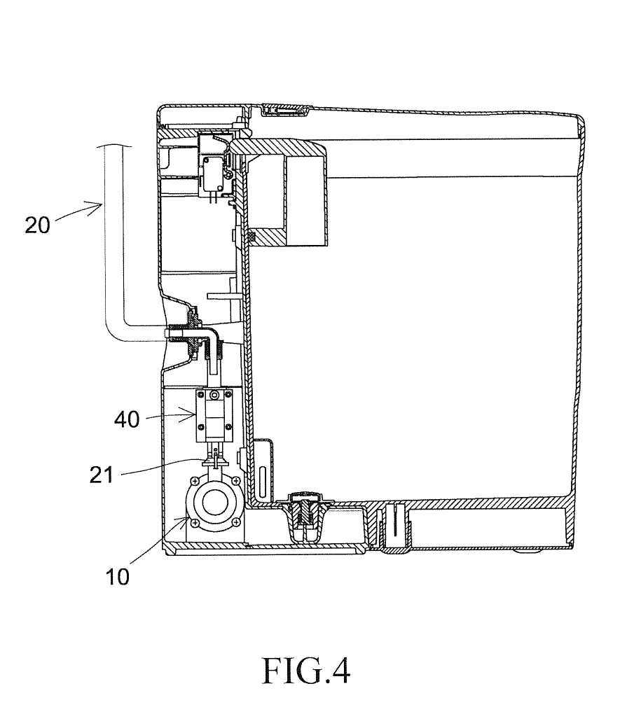

The present invention also provides a device to use the method described above to control the water outgoing by water pressure. As shown in FIGS. 2 to 7, the device comprises a motor 10, an outgoing pipe 20, a water outgoing unit 30, a thin film sensing device 40 and a check valve unit 21.

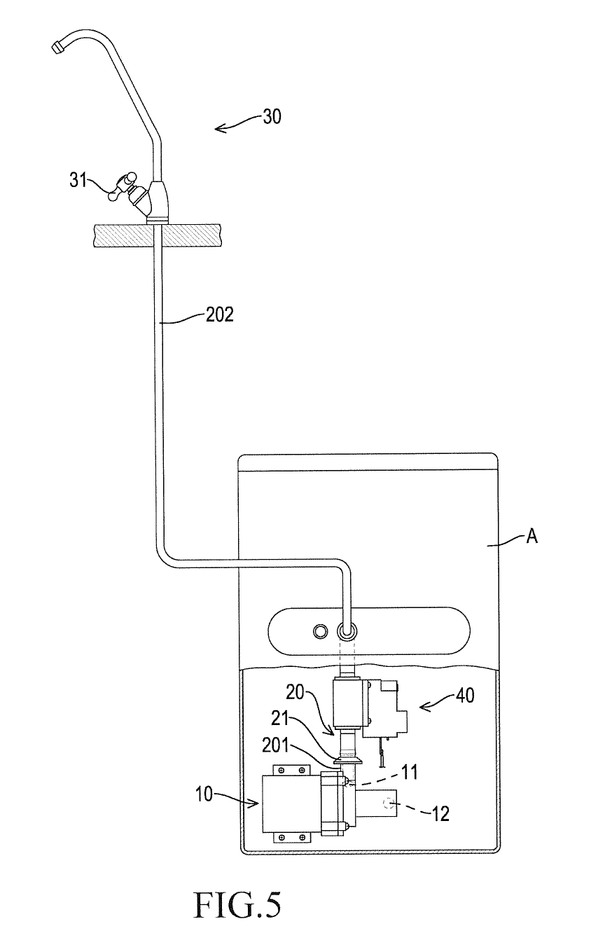

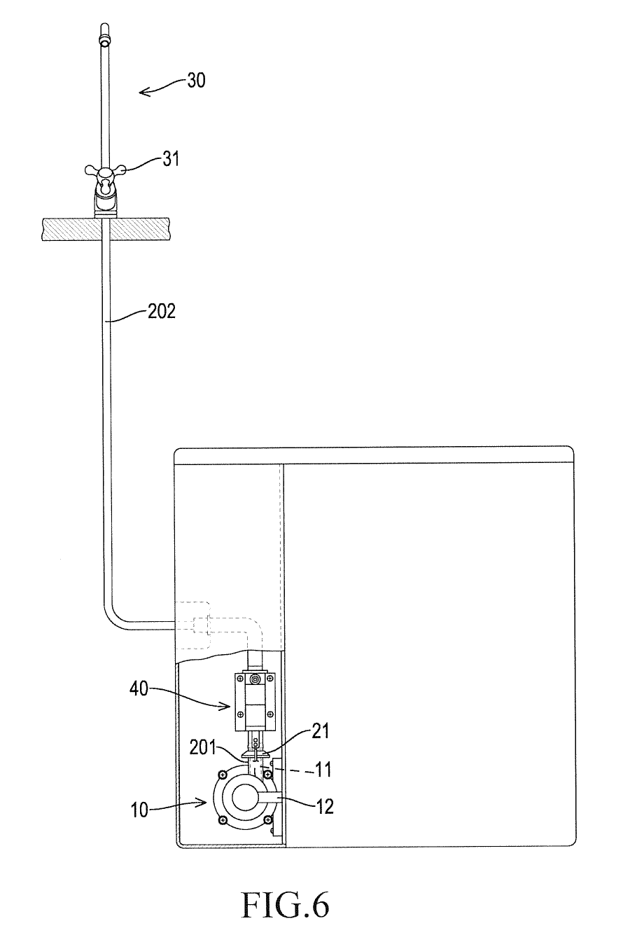

As shown in FIGS. 5 and 6, the motor 10 has an outlet 11 and an inlet 12, wherein the inlet 12 is connected with a container “A” which can be a water tank, a water vessel or any form of container. The motor 10 is connected to one side of the container “A”.

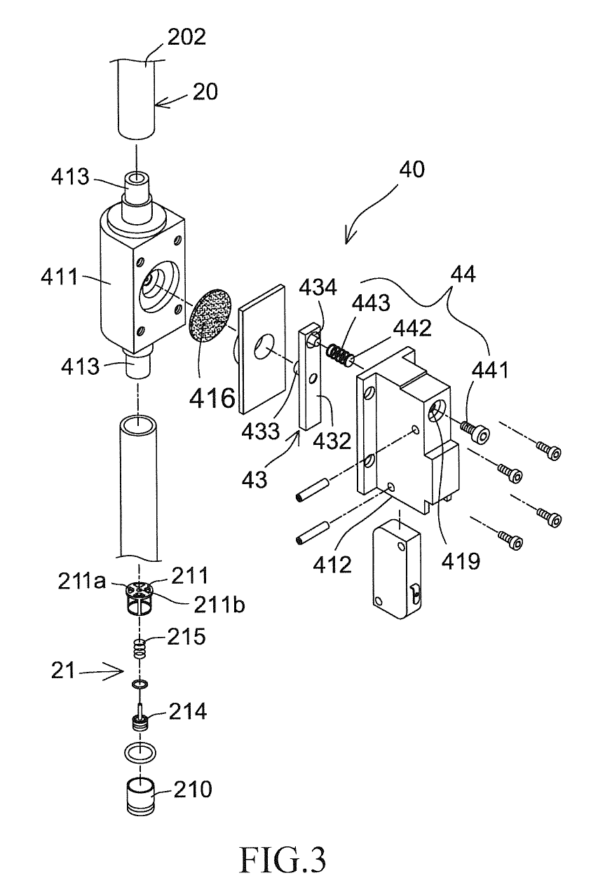

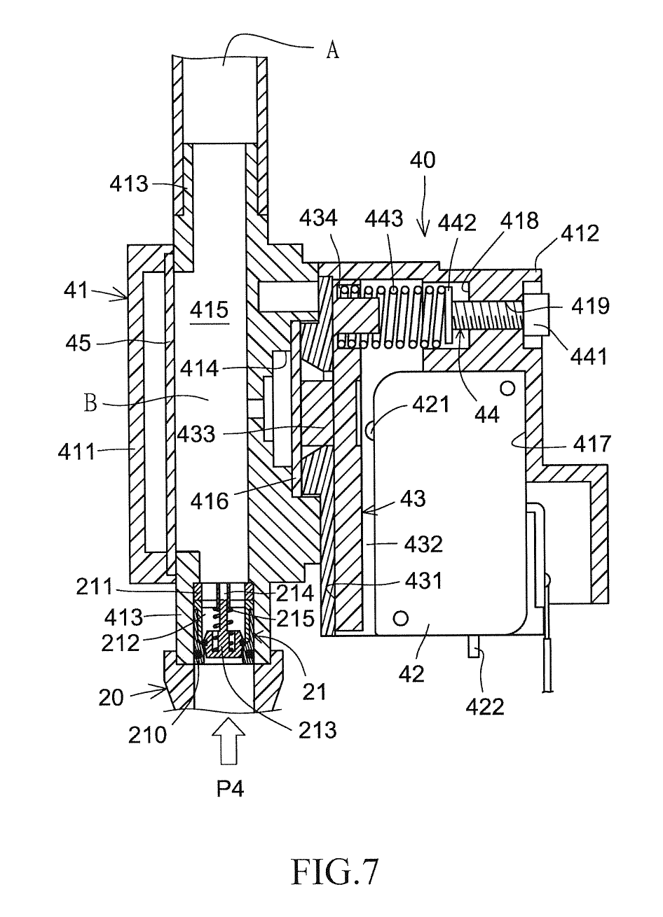

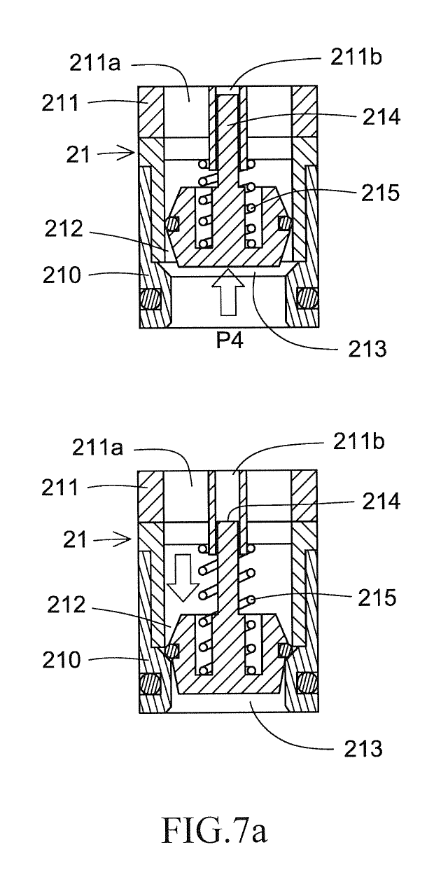

The outgoing pipe 20 is located in the container “A” to form the path allowing the water to flow out. The outgoing pipe 20 has an intake end 201 and an outgoing end 202, wherein the intake end 201 is connected to the outlet 11 of the motor 10. A check valve unit 21 is connected between the intake end 201 and the outgoing end 202 of the outgoing pipe 20. The check valve unit 21, as shown in FIGS. 3, 7 and 7a, includes a hollow body 210 and a porous top cap 211 connected to the hollow body 210. The top cap 211 has orifices 211a and reception area 211b. The top cap 211, the hollow body 210 form a path 212. The path 212 has a valve rod 214 and a spring 215 located in the reception area 211b. The spring 215 applies a force to the valve rod 214 to seal the entrance 213 of the path 212. When the water pressure P4 is that is generated by the operation of the suction motor 10 is larger than the spring force of the spring 215, the water enters into the outgoing pipe 20 via the entrance 213.

As shown in FIG. 5, the water outgoing unit 30 is connected to the outgoing end 202 of the outgoing pipe 20 and is connected with a valve 31 which controls the outgoing pipe 20 to allow the water to flow out or not. The water outgoing unit 30 is a mechanical unit which can be operated by way of rotating, pressing shifting or any other known method to open or close the mechanical unit. Therefore, the present invention can be used to hot water dispensers, —cold water dispensers and the water supply system of refrigerators.

As shown in FIG. 7, the thin film sensing device 40 is connected to the outgoing pipe 20 between the check valve unit 21 and the outgoing end 202, and comprises a connection member 41, a switch 42, a movable member 43 and an adjustment member 44. The connection member 41 comprises a body 411 and a cover 412, wherein the body 411 has two connection pipes 413 on the top and the bottom thereof. The body 411 further has a lateral opening 414 with which the cover 412 is connected.

The two connection pipes 413 are respectively connected to the mediate portion of the outgoing pipe 20. A pressure storage space 415 is defied in the connection member 41, the two connection pipes 413 and the lateral opening 414 respectively communicate with the pressure storage space 415. The pressure storage space 415 has a pressure-storage thin film 45 located therein. A first thin film 416 is connected in front of the lateral opening 414 so as to separate the pressure storage space 415 and the cover 412. An installation room 417 is defined in the cover 412 and located corresponding to the lateral opening 414. A reception room 418 is located beside the installation room 417. A threaded hole 419 is defined through the cover 412 and communicates with the reception room 418.

The switch 42 is installed to the installation room 417 and has a press end 421 and a contact end 422. The press end 421 is located corresponding to the lateral opening 414, and the contact end 422 is electrically connected to the motor 10.

The movable member 43 is located between the switch 42 and the first thin film 416, and has an inside 431 and an outside 432. The inside 431 faces the first thin film 416, and the opposite side to the inside 431 is the outside 432. A press portion 433 protrudes from the inside 431 and a spring room 434 is defined in the outside 432 and faces the reception room 418. The outside 432 of the movable member 43 contacts the press end 421 of the switch 42.

The adjustment member 44 is located in the reception room 418 and has an adjustment bolt 441, a push plate 442 and a spring 443. The adjustment bolt 441 is threadedly connected to the threaded hole 419 and inserted into the reception room 418. The push plate 442 and the spring 443 are located in the reception room 418. The push plate 442 is in contact between the front end of the adjustment bolt 441, and the spring 443 is biased between the push plate 442 and the movable member 43. The movable member 43 has a protrusion to which the spring 443 is mounted.

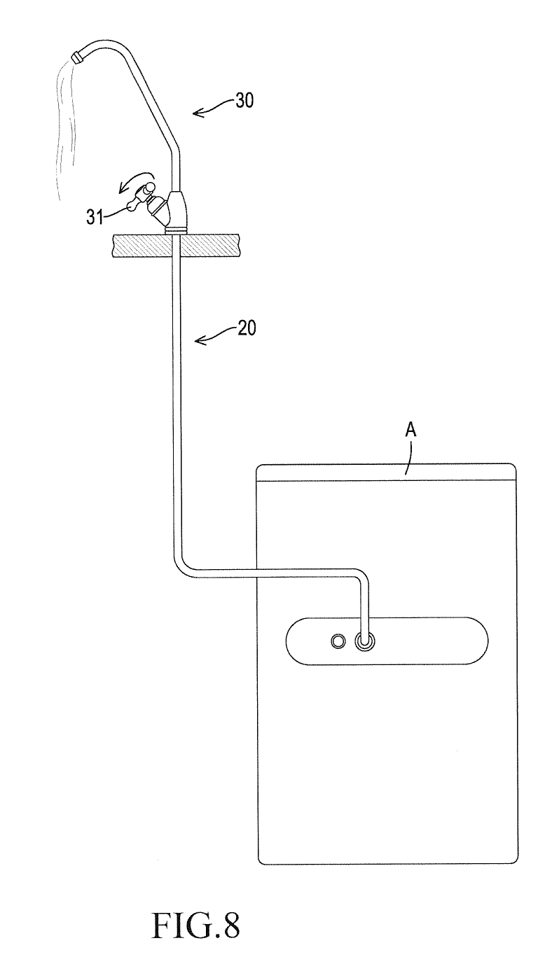

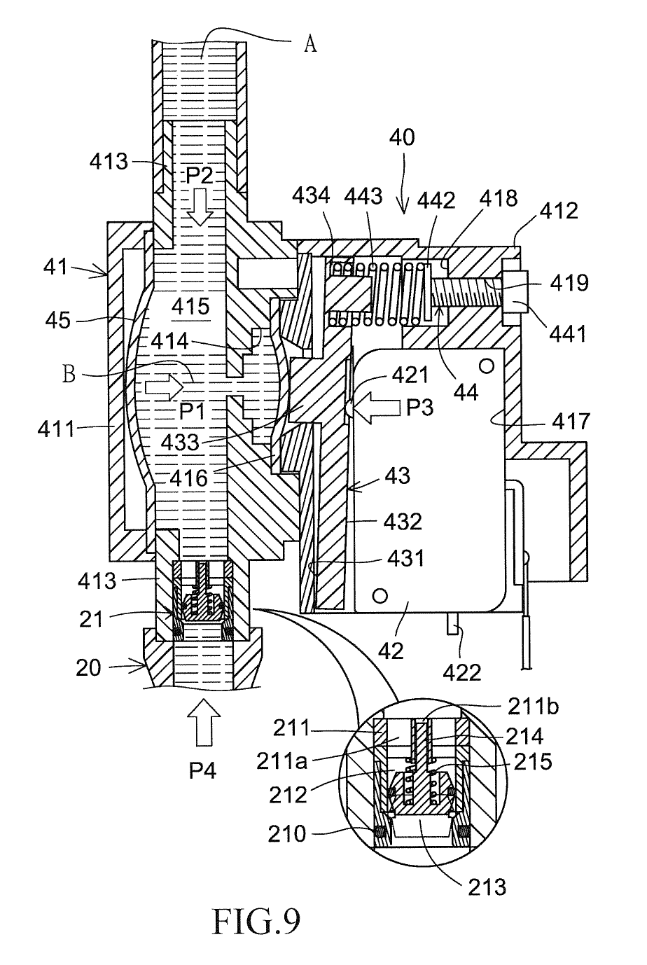

As shown in FIGS. 8 and 9, when using the device of the present invention, the motor 10 pumps water from the container “A” into the outgoing pipe 20. When the water is pumped and enters the outgoing pipe 20 and then enters into the entrance 213, the water pushes the valve rod 214 upward and flows through the porous top cap 211 to the water outgoing unit 30. When the water flows back and toward the entrance 213, the water pressure pushes the valve rod 214 to seal the entrance 213 so that the water cannot flow back and can only flow toward the water outgoing unit 30. When the user opens the valve 31 of the water outgoing unit 30, the water flows from the water outgoing unit 30.

As shown in FIG. 9, assume that the area between the water outgoing unit 30 and the thin film sensing device 40 is defined as area A, and the pressure-storage space 415 in the thin film sensing device 40 is defined as area B, when the user opens the water outgoing unit 30 to get the water, the thin film force P1 in the area B and the resistance force P3 at the press end 421 of the switch 42 are in a balanced status, and the switch 42 is in ON status. When the user shuts down the valve 31 of the water outgoing unit 30, the motor 10 continuously pumps the water while the water outgoing unit 30 is closed, the water cannot flow back to the container “A” because of the check valve unit 21. The water will be accumulated in the outgoing pipe 20 and enters into the connection member 41 of the thin film sensing device 40. The thin film sensing device 40 has the pressure storage space 415 so that when the water is accumulated in the pressure storage space 415, the flow-back water pressure P2 increases and the pressure-storage thin film 45 in the area B protrudes and generates the thin film force P1. The water pushes the first thin film 416 and the first thin film 43 horizontally in the connection member 41. When the sum of the thin film force P1 and the flow-back water pressure P2 is larger than the resistance force P3 at the press end 421 of the switch 42, the contact end 422 of the movable member 43 contacts the press end 421 of the switch 42. The switch 42 sends a control signal to stop the suction motor 10 and no water is supplied to the outgoing pipe 20. The water pressure P4 due to the operation of the suction motor 10 is disappear so that the spring 215 pushes the valve rod 214 to seal the entrance 213 to prevent the water from flowing back into the container A and to keep the pressure in the pressure-storage space 415. It is noted that the pressure-storage thin film 45 is optionally installed according to the length of the outgoing pipe 20 so as to store and increase the pressure.

When the user opens the water outgoing unit 30 again, the water in the outgoing pipe 20 before the check valve unit 21 will flow out first because the pressure is released, so that the pressure of the outgoing pipe 20 and the pressure storage space 415 is reduced gradually, so that the first thin film 416 and the movable member 43 move back to their initial positions and the movable member 43 is separated from the press end 421 of the switch 42. Therefore, the motor 10 pumps water again.

Besides, the pressure in the outgoing pipe 20 varies due to the factors of the length of the outgoing pipe 20, the distance that the water is delivered and the head of the water, so that the user may rotate the adjustment bolt 441 relative to the connection member 41 to adjust the distance between the spring 443 and the movable member 43 to increase or reduce the force of the spring 443. More water can be stored in the outgoing pipe 20 and the pressure storage space 415 until the water pressure overcomes the spring force of the spring 443, so that the movable member 43 contacts the press end 421 again to stop the operation of the motor 10. The movable member 43 is operated as a leverage, when one end of the movable member 43 is released, the movable member 43 returns to its initial position by the spring force.

While we have shown and described the embodiment in accordance with the present invention, it should be clear to those skilled in the art that further embodiments may be made without departing from the scope of the present invention.

What is claimed is:

1. A method for controlling water supply from a container, comprising:
a step of installing a water outgoing unit: connecting a motor to an outside of a container and the motor connected with an outgoing pipe, which is connected with a mechanical water outgoing unit;
a step of installing a pressure storage space: connecting a connection member in series with the outgoing pipe located between the motor and the water outgoing unit, the connection member having a lateral opening to which a switch is connected, a first thin film connected between the connection member and the switch to form a pressure storage space;
a step of controlling water outgoing by pressure: when the water outgoing unit is opened, the first thin film is horizontally located to set the switch to be “ON” and the motor continuously pumps the water, when a pressure is formed in the pressure storage space to deform the first thin film which protrudes to touch the switch to be “OFF”, the motor is stopped, and
a step of installing a check valve unit: connecting the water outgoing pipe to a front end of the connection member, when the motor is stopped, the check valve unit prevents the water in the water outgoing pipe from flowing back into the container to keep a pressure in the pressure storage space.

2. The method as claimed in claim 1, wherein the step of installing a pressure storage space includes a pressure-storage thin film which generates a thin film force, a flow-back water pressure is generated when the water outgoing unit is closed, a sum of the thin film force and the flow-back water pressure is larger than a resistance force when the switch is closed so that the first thin film contacts the switch to set the switch to be OFF.

3. A device for controlling water outgoing from a container by pressure, comprising:
a motor connected with a container;
a outgoing pipe having a front end and a rear end, the front end connected with the pump;
a water outgoing unit being a mechanical switch and connected to the rear end of the outgoing pipe;
a thin film sensing device connected to the outgoing pipe and having a connection member and a switch, the connection member connected to a mediate portion of the outgoing pipe, the connection member having a pressure storage space defined therein, which communicates with the outgoing pipe, a first thin film connected in the pressure storage space and the switch connected to an outside of the first thin film, and
a check valve unit connected to the outgoing pipe between the thin film sensing device and the motor, the check valve unit preventing water from flowing backward, when a pressure is formed in the pressure storage space to deform the first thin film which protrudes to touch the switch which stops the motor.

4. The device as claimed in claim 3, wherein the thin film sensing device comprises an adjustment member which is located beside the switch, the adjustment member has a movable member, an adjustment bolt, a push plate and a spring, the movable member is located between the first thin film and the switch, the adjustment bolt rotatably extends in the connection member, the push plate is in contact with a front end of the adjustment bolt, the spring is biased between the push plate and the movable member.

5. The device as claimed in claim 3, wherein the connection member has a body and a cover, the body has two connection pipes on a top and a bottom thereof, the body has a lateral opening which is located corresponding to the cover, the two connection pipes are connected to the outgoing pipe, the two connection pipes and the lateral opening respectively communicate with the pressure storage space.

6. The device as claimed in claim 5, wherein the pressure-storage space has a pressure-storage thin film so as to generate a thin film force, a flow-back water pressure is generated when the water outgoing unit is closed, a sum of the thin film force and the flow-back water pressure is larger than a resistance force when the switch is closed so that the first thin film contacts the switch to set the switch to be OFF.
